(19) United States
(12) Patent Application Publication
(10) Pub. No.: US 2007/0194126 A1
(43) Pub. Date: Aug. 23, 2007

(54) Wireless telecommunication device, decoding system, computer program and method

(75) Inventors: Karri Niemela, Oulu (FI); Heimo Keranen, Oulu (FI); Pekka Koivukunnas, Jarvenpaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Avantone Oy

(21) Appl. No.: 11/348,157

(22) Filed: Feb. 6, 2006

(51) Int. Cl. G06K 7/10

(52) U.S. Cl. 235/472.02

(57) ABSTRACT

The invention relates to decoding digital information, where a surface of an object is illuminated with a first optical illumination from a first direction, the surface comprising microscopic embossed data units encoding digital information. A first primary digital microscopic image is recorded from the microscopic embossed data units with the first optical illumination. The surface is further illuminated with a second optical illumination from a second direction different from the first direction, and a second primary digital microscopic image is recorded from the microscopic embossed data units with the second optical illumination. A secondary digital microscopic image of the microscopic embossed data units is generated from the first primary digital microscopic image and the second primary digital microscopic image, and at least a part of the digital information is generated from the secondary digital microscopic image.

### BACKGROUND OF THE INVENTION

The invention relates to a wireless telecommunication device, a decoding system, a computer program, and a method of decoding digital information.

Bar codes printed on a printing surface is a widely used technology for encoding digital information and transferring digital information. The bar codes are typically read with a reader dedicated to reading bar codes. However, conventional ink-based bar codes are relatively large and require a relatively large amount of space on the printing surface, thus reducing the space for other purposes, such as graphs and text. Therefore, it is useful to consider techniques for decoding digital information.

### BRIEF DESCRIPTION OF THE INVENTION

An object of the invention is to provide an improved wireless telecommunication device, decoding system, computer program and method. According to a first aspect of the invention, there is provided a wireless telecommunication device comprising: an illuminating system for illuminating a surface of an object with a first optical illumination from a first direction, the illumination system further being configured to illuminate the surface with a second optical illumination from a second direction different from the first direction, the surface comprising microscopic embossed data units encoding digital information; a digital microscope camera for recording a first primary digital microscopic image from the microscopic embossed data units with the first optical illumination, the digital microscope camera further being configured to record a second primary digital microscopic image from the microscopic embossed data units with the second optical illumination; an image processing unit for generating a secondary digital microscopic image of the microscopic embossed data units from the first primary digital microscopic image and the second primary digital microscopic image; and an image decoder for decoding at least a part of the digital information from the secondary digital microscopic image.

According to a second aspect of the invention, there is provided a wireless telecommunication device comprising: an illuminating means for illuminating a surface of an object with a first optical illumination from a first direction, the illuminating means further being configured to illuminate the surface with a second optical illumination from a second direction different from the first direction, the surface comprising microscopic embossed data units encoding digital information; a recording means for recording a first primary digital microscopic image from the microscopic embossed data units with the first optical illumination, the recording means further being configured to record a second primary digital microscopic image from the microscopic embossed data units with the second optical illumination; a generating means for generating a secondary digital microscopic image of the microscopic embossed data units from the first primary digital microscopic image and the second primary digital microscopic image; and a decoding means for decoding at least a part of the digital information from the secondary digital microscopic image.

According to a third aspect of the invention, there is provided a decoding system for decoding digital information, comprising: an illuminating means for illuminating a surface of an object with a first optical illumination from a first direction, the illuminating means being located in a wireless telecommunication device and configured to illuminate the surface with a second optical illumination from a second direction different from the first direction, the surface comprising microscopic embossed data units encoding digital information; a recording means for recording a first primary digital microscopic image from the microscopic embossed data units with the first optical illumination, the recording means being located in a wireless telecommunication device and configured to record a second primary digital microscopic image from the microscopic embossed data units with the second optical illumination; a generating means, located in a computing system, for generating a secondary digital microscopic image of the microscopic embossed data units from the first primary digital microscopic image and the second primary digital microscopic image; and a decoding means, located in a computing system, for decoding at least a part of the digital information from the secondary digital microscopic image.

According to a fourth aspect of the invention, there is provided a computer program encoding instructions for executing a computer process, wherein the computer process is suitable for decoding digital information and comprises: outputting a command for illuminating a surface of an object with a first optical illumination from a first direction, the surface comprising microscopic embossed data units encoding digital information; recording a first primary digital microscopic image from the microscopic embossed data units with the first optical illumination; outputting a command for illuminating the surface with a second optical illumination from a second direction different from the first direction; recording a second primary digital microscopic image from the microscopic embossed data units with the second optical illumination; generating a secondary digital microscopic image of the microscopic embossed data units from the first primary digital microscopic image and the second primary digital microscopic image; and decoding at least a part of the digital information from the secondary digital microscopic image.

According to another aspect of the invention, there is provided a method of decoding digital information, comprising: illuminating a surface of an object with a first optical illumination from a first direction, the surface comprising microscopic embossed data units encoding digital information; recording a first primary digital microscopic image from the microscopic embossed data units with the first optical illumination; illuminating the surface with a second optical illumination from a second direction different from the first direction; recording a second primary digital microscopic image from the microscopic embossed data units with the second optical illumination; generating a secondary digital microscopic image of the microscopic embossed data units from the first primary digital microscopic image and the second primary digital microscopic image; and decoding at least a part of the digital information from the secondary digital microscopic image.

The invention provides several advantages. The invention enables obtaining digital information from microscopically dimensioned data embossed onto a surface of an object by using a wireless telecommunication device. The microscopic data units may overlap a conventional printing, thus enabling the reuse of the surface.

### BRIEF DESCRIPTION OF THE DRAWINGS

In the following, the invention will be described in greater detail with reference to the embodiments and the accompanying drawings, in which

FIG. 1 shows an example of a structure of a wireless telecommunication device;

FIG. 2 illustrates a first example of a decoding system;

FIG. 3 illustrates a second example of a decoding system;

FIG. 4 illustrates a third example of a decoding system;

FIG. 5 illustrates a first example of a wireless telecommunication device;

FIG. 6 illustrates a second example of a wireless telecommunication device;

FIG. 7 illustrates an example of a methodology according to an embodiment of the invention;

FIG. 8 shows a flow chart of a computer process according to an embodiment of the invention, and

FIG. 9 shows an example of a structure of a computing system.

### DETAILED DESCRIPTION OF THE INVENTION

With reference to an example of FIG. 1, a wireless telecommunication device (WTD) 100 typically comprises an antenna 112 and a transceiver 102 for implementing a radio interface 114 with an infrastructure of the wireless telecommunications system. The wireless telecommunication device 100 may also be referred to as a mobile phone, a cellular phone, user equipment, a mobile station, a mobile terminal and/or a wireless telecommunication modem. The present solution is not, however, restricted to listed devices, but may be applied to any wireless telecommunication device connectable to a wireless telecommunication network.

The wireless telecommunication network may be based on the following radio access technologies: GSM (Global System for Mobile Communications), GERAN (GSM/EDGE Radio access network), GPRS (General Packet Radio Service), E-GPRS (EDGE GPRS), UMTS (Universal Mobile Telecommunications System), CDMA2000 (CDMA, Code Division Multiple Access), US-TDMA (US Time Division Multiple Access) and TDS-CDMA (Time Division Synchronization CDMA).

The air interface 114 may also be a short-range radio link, such as a WLAN (Wireless Local Access Network) or a BlueTooth link.

The invention is not, however, restricted to the listed radio access technologies, but may be applied to a wireless telecommunication device of any wireless telecommunication network.

The wireless telecommunication device 100 further comprises a digital processor 104 and a memory unit 106, which together form a part of a computer of the wireless telecommunication device 100. The memory unit 106 may store encoded instructions for executing a computer process in the digital processor 104.

The wireless telecommunication device 100 further comprises a user interface 108 for providing the user with capability of communicating with the wireless telecommunication device 100. The user interface 108 may include audiovisual devices, such as a display, microphone and a sound source. The user interface 108 may further include an input device, such as a keyboard, a keypad or a touch display.

The wireless telecommunication device 100 further comprises a microscope imaging system 110 for recording digital microscope images from microscopic embossed data units located on a surface 118 of an object 116.

The microscopic imaging system 110 emits optical radiation 120 to the surface 118 and receives response optical radiation 122 as a response to the optical radiation 122.

The object 116 is typically made of material enabling microscopic embossed patterns to be formed on the surface 118 of the object 116. The material of the object 116 may be, for example, cardboard, paper, plastic, metal or fiber.

The object 116 may be a package of a product, a tag attachable to a package or the product, or a product.

The microscopic embossed data units encode digital information. A microscopic embossed data unit is typically a microscopic elevated or a depressed structure on the surface of the object 116.

The microscopic embossed data units may comprise spot-like or elongated structures extending from the surface 118. A dimension of a microscopic embossed data unit is typically in the micrometer scale, such as between 0.5 μm and 200 μm. A height of a microscopic embossed data unit may be from 0.1 μm to 100 μm. The invention is not, however, restricted to the given dimensions and shapes of the microscopic embossed data units, but may be applied to any surface comprising a microscopic embossed data unit that encodes digital information.

In an embodiment of an invention, the embossed data units are microscopic bar codes.

The digital information may be encoded into the characteristics of the microscopic embossed data units. The characteristics comprise, for example, location, height, cross-section, shape, optical absorption properties and optical spectral characteristics of the microscopic embossed data units. The optical characteristics may comprise diffraction characteristics, scattering characteristics, and glossiness of the microscopic embossed data units.

In this context, the term “embossed” is not restricted to an embossing method when generating the elevated and/or the depressed structures. The microscopic embossed data unit may have been generated with a laser technique, an ink-like substance placed on the surface of the object 116, a conventional embossing method or any method capable of producing microscopic elevated and/or depressed structures on the surface of the object 116.

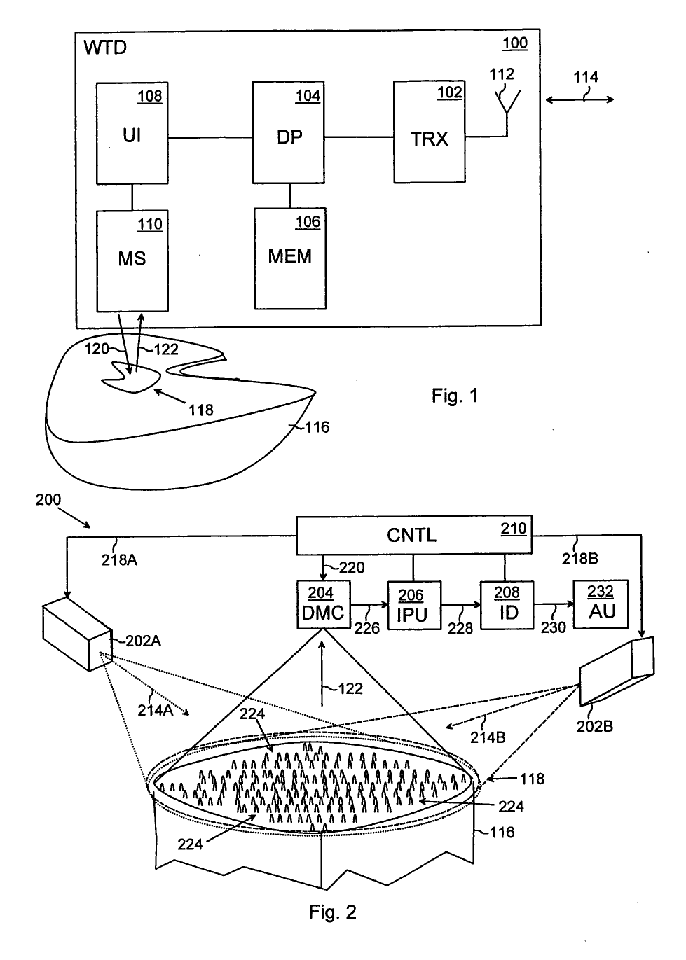

With reference to FIG. 2, the decoding system 200 comprises an illuminating system 202A, 202B, a digital microscope camera (DMC) 204, an image processing unit (IPU) 206 connected to the digital microscope camera 204, and an image decoder (ID) 208 connected to the image processing unit 206. The decoding system 200 may further comprise a controller 210, which may control the illuminating system 202A, 202B and the digital microscope camera 204. The controller 210 may further control the image processing unit 206 and/or the image decoder 208.

The illuminating system 202A, 202B may comprise a first optical radiation source 202A, which illuminates the surface 118 of the object 116 with a first optical illumination 214A. The first illumination 214A is directed at the surface 118 from a first direction.

The illumination system 202A, 202B may further comprise a second optical radiation source 202B, which illuminates the surface 118 with a second optical illumination 214B from a second direction, which is different from the first direction.

The first optical radiation source 202A and the second optical radiation source 202B are optical radiation sources capable of emitting radiation at optical wavelength range, which typically covers wavelengths from 10 nm to 1 mm.

The first optical radiation source 202A and/or the second optical radiation source 202B may be primary radiation sources, such as a laser, a LED (Light emitting diode), or a discharge lamp unit, which generate the optical radiation.

The first optical radiation source 202A and/or the second optical radiation source 202B may be secondary radiation sources, such as gratings or wave-guides, which receive optical radiation from a primary radiation source and redirect or emit the optical radiation to a desired direction.

The invention is not restricted to two optical illuminations. In an embodiment of the invention, the illumination system comprises three or more optical radiation sources, each providing an illumination from a different direction.

FIG. 2 further shows a digital microscope camera 204, which records a first primary digital microscopic image from the microscopic embossed data units 224 with the first optical illumination 214A. The digital microscope camera 204 further records a second primary digital microscopic image from the microscopic embossed data units 224 with the second optical illumination 214B.

The digital microscope camera 204 typically comprises microscope optics and a matrix detector. The microscope optics transfers response optical radiation 122 emitted by the microscopic embossed data units 224 onto the surface of the matrix detector.

The matrix detector comprises elementary detectors in an array configuration. Each elementary detector receives a portion of the response optical radiation 122 and generates an electric signal proportional to an intensity of the portion of the response optical radiation 122 hitting the elementary detector. A combination of the electric signals contains the information of the microscopic image of the microscopic embossed data units 224.

The matrix detector may be based on CCD (Charge Coupled Device) or CMOS (Complementary Metal-Oxide Semiconductor) technology, for example.

The microscope optics is typically designed so as to provide a thin optical structure to be applied in the wireless telecommunication device. A typical distance between the surface 118 and the matrix detector is typically from 5 mm to 50 mm, without restricting the invention to the given figures.

The optical magnification of the microscope optics is typically between 0.1 and 2, without restricting the invention to the given figures. The magnification may be selected according to the dimensions of the microscopic embossed data units 224, the resolution of the matrix detector, and/or the number of elementary detectors in the matrix detector. The optical magnification may be defined by the ratio of the length of a side of the matrix detector to the length of a side of the image area.

The effective focal length of the microscope optics is typically between 1 mm and 10 mm, without restricting the invention to the given figures.

In an embodiment of the invention, the illuminating system 202A, 202B illuminates the surface 118 with the first optical illumination 214A during a first time interval. The illuminating system 202A, 202B further illuminates the surface 118 with the second optical illumination 214B during a second time interval, which is different from the first time interval.

The first time interval and the second time interval may vary between 1/30 s and 5 s, without restricting the invention to the given figures.

The controller 210 may comprise encoded instructions for generating commands 218A, 218B which are outputted to the first radiation source 202A and the second radiation source 202B.

A first command 218A is inputted into the first radiation source 202A and includes instructions to activate the first radiation source 202A for the first time interval.

A second command 218B is inputted into the second radiation source 202B and includes instructions to activate the second radiation source 202B for the second time interval.

The first command 218A and the second command 218B may be voltage levels, which provide power for the first radiation source 202A and the second radiation source 202B.

The digital microscope camera 204 may receive a recording command 220 from the controller 210. The recording command 220 may include instructions to record the first primary digital microscopic image during the first time interval. The recording command 220 may further include instructions to record the second primary digital microscopic image during the second time interval. As a result, the first primary digital microscopic image comprises a microscopic image of the microscopic embossed data units 224 illuminated with the first optical illumination from the first direction. The second primary digital microscopic image comprises a microscopic image of the microscopic embossed data units 224 illuminated with the second optical illumination from the second direction. The method described above may be referred to as a time-divided microscopic imaging.

In the time-divided microscopic imaging, the wavelength of the optical radiation applied in the first optical illumination 214A and that applied in the second optical illumination may be the same or different.

In an embodiment of the invention, the illuminating system 202A, 202B illuminates the surface 118 with the first optical illumination 214A covering a first optical spectral range. The illuminating system 202A, 202B may further illuminate the surface 118 with the second optical illumination 214B covering a second optical spectral range different from the first optical spectral range.

The first radiation source 202A and the second radiation source 202B may have filters, such as a yellow and a red filter, respectively, which transmit optical radiation at desired wavelengths. A different wavelength may also arise from a different wavelength of a primary radiation source.

The digital microscope camera 204 may further record the first primary digital microscopic image at the first spectral range and record the second primary digital microscopic image at the second spectral range.

In an embodiment of the invention, the digital microscope camera 204 is sensitive to the different spectral ranges and is capable of recording the first microscopic digital image and the second microscopic digital image simultaneously.

The digital microscope camera 204 outputs primary image information 226 into the image processing unit 206. The primary image information 226 includes the first digital microscopic image and the second digital microscopic image.

The image processing unit 206 generates a secondary digital microscopic image of the microscopic embossed data units 224 from the first primary digital microscopic image and the second primary digital microscopic image. If three or more primary digital microscopic images are available, the image processing unit may generate a plurality of secondary digital microscopic images from the primary digital images.

In an embodiment of the invention, the image processing unit 206 generates topographic information of the microscopic embossed data units 224 from the first primary digital microscopic image and the second primary digital microscopic image and incorporates the topographic information into the secondary digital microscopic image.

In an embodiment of the invention, the image processing unit 206 calculates a difference image between the first primary digital microscopic image and the second primary digital microscopic image. In a mathematical form, the difference image I(x,y)_{DIFF} may be expressed as
I(x,y)_{DIFF}=C(I₁(x,y)−I₂(x,y)), (1)
where I₁ (x, y) and I₂ (x, y) are the intensities of the first digital microscopic image and the second digital microscopic image, respectively. Coordinates x and y characterize coordinates of the surface 118, and C is a scaling factor characterizing an imaging geometry. In an embodiment of the invention, the scaling factor C is reciprocal of tan γ, where γ is the elevation angle between the digital microscope camera and a primary illumination.

In an embodiment of the invention, the image processing unit 206 calculates a sum image of the first primary digital microscopic image and the second primary digital microscopic image and normalizes the difference image with the sum image. In such a case, the difference image may be written as

$${I ( x , y )}_{DIFF} = \frac{C ( {I}_{1} ( x , y ) - {I}_{2} ( x , y ) )}{{I}_{1} ( x , y ) + {I}_{2} ( x , y )} . \qquad ( 2 )$$

The use of the sum image as a normalization factor provides a topographically neutral image of the microscopic embossed data units 224. The sum image is not sensitive or only weakly sensitive to the topography of the surface. It may be calculated that for a Lambertian surface, i.e. for a surface providing diffuse scattering, the sum image presents reflectance of the surface.

The difference image may be interpreted as a partial derivative of the topography of the embossed data units 224. The calculation of the difference image emphasizes the surface gradient in the direction of the illumination.

The image processing unit 206 further integrates the difference image over a coordinate of the surface 118 and incorporates the integral into the secondary digital microscopic image. The integrated difference image may be interpreted as topography of the embossed data units 224. In mathematical terms, the secondary digital microscopic image S(x,y) may be written as

$$S ( x , y ) = S ( y ) + {\int }_{0}^{x} {I}_{DIFF} ( {x}^{′} , y ) ⅆ {x}^{′} , \qquad ( 3 )$$

where S(y) is an integration coefficient. The integral of Equation (3) may be calculated with a Fourier filtering method, for example.

The secondary digital microscopic image obtained from the integral of the difference image provides the topography, i.e., the height function of the microscopic embossed data units 224. The use of the topography allows the microscopic embossed data units 224 to be resolved from a surface 118 containing a conventional printing. The microscopic data units 224 can be intentionally embossed on a printed or partially printed surface, thus enabling reuse of the surface as an information platform.

The secondary digital microscopic image 228 is inputted into the image decoder 208, which decodes the digital information from the secondary digital microscopic image 228.

The image decoder 208 carries out an encoding process, which may comprise identifying predefined structures from the secondary digital microscopic image 228, and interpreting the predefined structures as pieces of the digital information.

In an embodiment of the invention, the decoding system further comprises an application unit 232, which receives the digital information 230 from the image decoder 208. The application unit 232 executes an application based on the digital information 230. The application unit 232 may be implemented with a computer program encoding instructions to be executed in the digital processor 104 and stored in the memory unit 106

With further reference to FIG. 2, the image processing unit 206 may be implemented with a computer program encoding instructions to be executed in the digital processor 104 and stored in the memory unit 106.

The image decoder 208 may be implemented with a computer program encoding instructions to be executed in the digital processor 104 and stored in the memory unit 106.

The controller 210 may be implemented with a computer program encoding instructions to be executed in the digital processor 104 and stored in the memory unit 106.

In an embodiment of the invention, the digital information 230 comprises an authentication key for authenticating the object 116. The application unit 232 may comprise, for example, a register with a list of keys, with which the authentication key obtained from the embossed data units 224 is compared. If the authentication key matches any of the keys on the list, the application unit 232 may grant an authentication to the product. The authentication may be used, for example, to verify the origin of the product and to recognize counterfeit products.

In an embodiment of the invention, the digital information 230 comprises a connection address, such as a web address, WAP (Wireless Access Protocol) address or a phone number. The digital information may further comprise instructions for the wireless telecommunication device 100 to connect to the address. The application unit 232 may execute a part of a protocol required to establish the connection.

In an embodiment of the invention, the digital information 230 comprises a message, such as an SMS (Short Message Service). The digital information may further comprise a connection address to which the message is to send. The application unit 232 may link the message to the messaging system of the wireless telecommunication device 100 and instruct the messaging system to sent the message to the address.

In an embodiment of the invention, the digital information 230 comprises a digital image, which may be set as a wallpaper, for example, of the wireless telecommunication device 100. The application unit 232 may create required link information in the file system of the wireless telecommunication system 100 in order to associate the digital image with the wallpaper.

In an embodiment of the invention, the digital information 230 comprises setting information for configuring the wireless telecommunication device 100. The application unit 232 may include instructions to configure the wireless telecommunication device 100 according to the setting information. The setting information may further comprise address information, such as an electric business card.

In an embodiment of the invention, the digital information 230 comprises an audio file. The application unit 232 may link the audio file to an audio player capable of playing the audio file. The application unit 232 may include the audio player.

In an embodiment of the invention, the digital information 230 comprises a key for providing an access to an application. The application may be a game application, for example.

In an embodiment of the invention, the digital information 230 comprises at least a part of a computer program to be executed in the wireless telecommunication device 100. The application unit 230 may translate the digital information 230 into an executable computer program.

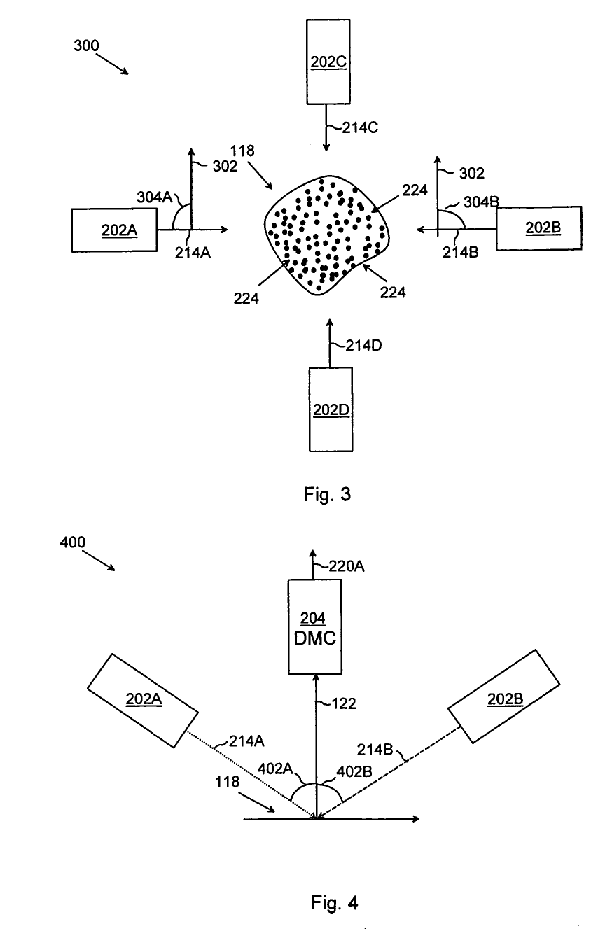

With reference to FIG. 3, an illumination geometry 300 is shown from an imaging direction. In an embodiment of the invention, the illuminating system 202A, 202B illuminates the surface 118 from the first direction associated with a first incident azimuth angle 304A. The illuminating system 202A, 202B further illuminates the surface 118 from the second direction associated with a second incident azimuth angle 304B different from the first incident azimuth angle 304A.

The first azimuth angle 304A and the second azimuth angle 304A are 304B defined as an angular difference of the first direction and the second direction, respectively, from an azimuth angular reference 302. The azimuth angular reference 302 is perpendicularly oriented relative to the imaging direction.

The difference between the first azimuth angle 304A and the second azimuth angle 304B may vary between 150 degrees and 210 degrees without restricting the invention to the given figures.

In an embodiment of the invention, the first incident azimuth angle 304A and the second incident azimuth angle 304B are opposite angles. In such a case, the difference between the first azimuth angle 304A and the second azimuth angle 304B is about 180 degrees. The opposite azimuth angles 304A, 304B are close to optimal angles when applying the method of calculating the difference image referred to in Equations (1) to (3).

With further reference to FIG. 3, the illuminating system may comprise further optical radiation sources 202C, 202D, which provide optical illuminations 214C and 214D from different directions, respectively.

With reference to FIG. 4, an imaging geometry 400 is shown from a perpendicular direction relative to the imaging direction.

The first optical illumination 214A is associated with a first elevation angle 402B, and the second optical illumination is associated with a second elevation angle 402B. The first elevation angle 402A and the second elevation angle 402B are shown relative to the direction of the response optical radiation 122.

The first elevation angle 402A and the second elevation angle 402B may vary between 0 degrees and 85 degrees, without restricting the invention to the given figures. A large elevation angle may be applied to a diffuse scattering surface and to microscopic data units with flat structure. A small elevation angle may be applied to a case where the encoding of the digital information is based on the glossiness of the surface of the object 116.

With further reference to FIGS. 3 and 4, an illumination and imaging geometry may be selected according to the characteristics of the microscopic embossed data units 224. In some applications, the microscopic embossed data units 224 may form diffractive elements, which involve specific angles of the illumination and angles of the response optical radiation 122. Therefore, the configuration, i.e. the first direction and the second direction, of the illuminating system 202A to 202D may be selected according to the characteristics of the microscopic embossed data units 224.

In an embodiment of the invention, the location of the digital microscopic camera 204 may be selected according to the characteristics of the microscopic embossed data units 224.

In an embodiment of the invention, the image process unit 206 is configured according to characteristics of the microscopic embossed data units 224.

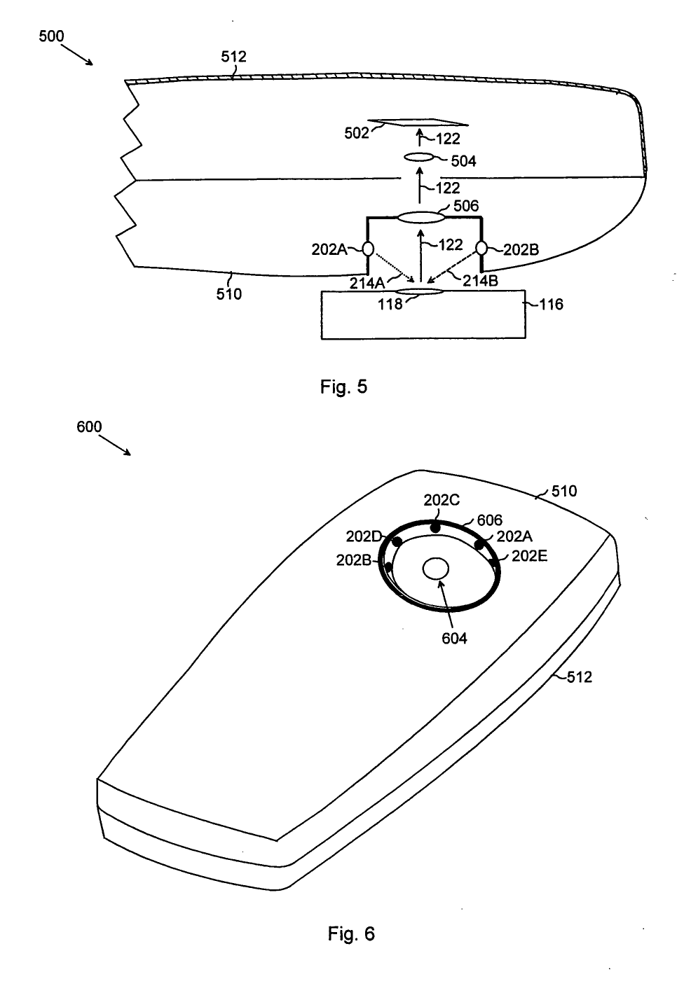

With reference to an example of FIG. 5, in an embodiment of the invention, the wireless telecommunication device comprises an integrated matrix detector 502 integrated into the wireless telecommunication device 500. The wireless telecommunication device 500 may further comprise a microscope imaging module 510, which comprises optics 506 for providing means for microscopic imaging. The microscope imaging module 510 further comprises the illuminating system 202A, 202B and an interface for enabling post-installation of the microscope imaging module 510 into the wireless telecommunication device 500.

The integrated matrix detector 502 is typically part of the camera of a bulk wireless telecommunication device 500. The wireless telecommunication device 500 may further comprise integrated optics 504, which are designed for conventional digital photography.

The microscope imaging module 510 may be integrated into a back cover of the wireless telecommunication device 500. In such a case, the interface comprises attaching means, which are compatible with the back of the front cover 512 of the wireless telecommunication device 500.

The use of the integrated matrix detector 502 and the microscope imaging module 510 enables different and commercially available wireless telecommunication devices to be applied as a platform for the microscope imaging module 510.

With reference to FIG. 6, the wireless telecommunication device 600 is shown from another perspective. Figure shows the front cover 512 and the microscope imaging module 510 with radiation sources 202A to 202E located in the circumference of an imaging aperture 604. FIG. 6 further shows a light block 606 for reducing external light entering to the surface.

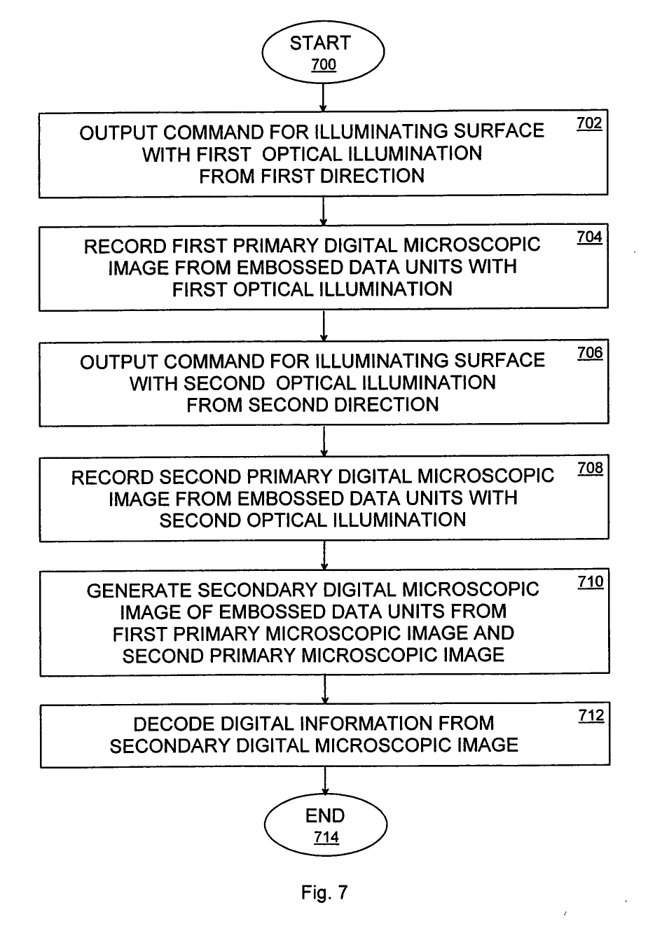

With reference to FIG. 7, a computer program encoding instructions for executing a computer process suitable for decoding digital information is shown with a flow chart.

In 700, the computer process is started.

In 702, a command 218A is outputted for illuminating a surface 118 of an object 116 with a first optical illumination 214A from a first direction, the surface 118 comprising microscopic embossed data units 224 encoding digital information.

In 704, a first primary digital microscopic image is recorded from the microscopic embossed data units 224 with the first optical illumination 214A.

In 706, a command 218B is outputted for illuminating the surface 118 with a second optical illumination 214B from a second direction different from the first direction.

In 708, a second primary digital microscopic image is recorded from the microscopic embossed data units 224 with the second optical illumination 214B.

In 710, a secondary digital microscopic image of the microscopic embossed data units 224 is generated from the first primary digital microscopic image and the second primary digital microscopic image.

In an embodiment, topographic information of the microscopic embossed data units 224 is generated 710 from the first primary digital microscopic image and the second primary digital microscopic image and the topographic information is incorporated into the secondary digital microscopic image.

In an embodiment, a difference image between the first primary digital microscopic image and the second primary digital microscopic image is calculated, and integral of the difference image over the surface is calculated. Furthermore, the integral is incorporated into the secondary digital microscopic image.

In an embodiment of the invention, a sum of the first primary digital microscopic image and the second primary digital microscopic image is calculated and the difference image is normalized with the sum image. Furthermore, the integral is incorporated into the secondary digital microscopic image.

In 712, at least a part of the digital information is decoded from the secondary digital microscopic image.

In 714, the computer process ends.

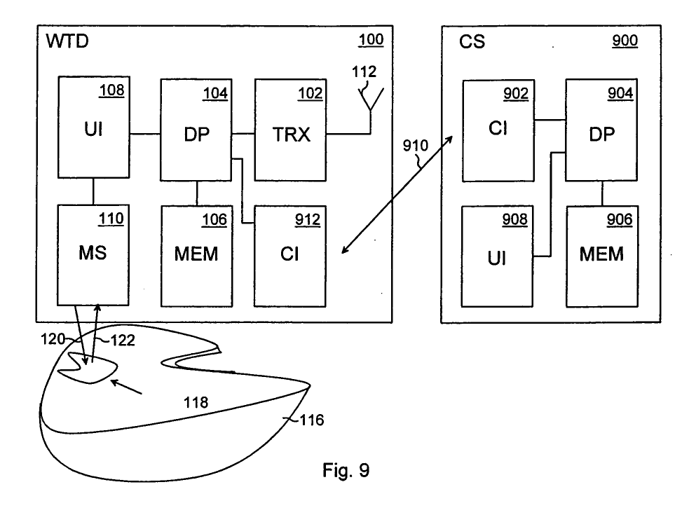

With reference to FIG. 9, in an aspect, the invention provides a decoding system comprising a wireless telecommunication device 100 and a computing system (CS) 900.

Steps 700 to 708 may be carried out in the digital processor 204 of the wireless telecommunication device 100. Steps 710 to 712 may be carried out in the digital processor 204 of the wireless telecommunication device 100. In an embodiment of the invention, steps 710 to 714 are carried out in a digital processor 904 of the computing system 900.

In an embodiment of the invention, the digital processor 904 of the computing system 900 implements the application unit 232 of FIG. 2.

The first primary digital microscopic image and the second primary microscopic image may be incorporated into a communication signal 910 communicated between a communication interface 912 of the wireless telecommunication device 100 and a communication interface 902 of the computing system 900.

The computing system 900 may further comprise memory 906 for storing encoded instructions of the computer program, and a user interface 908 for providing the user with capability to communicate with the computing system 900.

The communication interfaces 902, 912 may be based on a wired communication or a wireless communication, such as the BlueTooth.

The computing system 900 may comprise another wireless telecommunication device, a personal computer, a laptop or any computing system capable of carrying out steps 710 to 714.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

The computer program may further be incorporated into a computer program product.

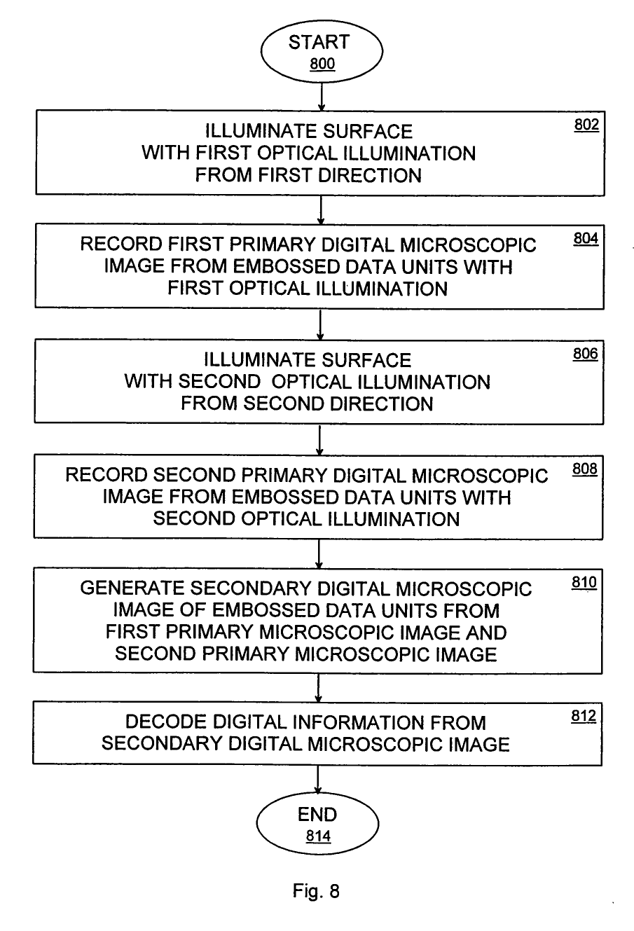

With reference to FIG. 8, methodology according to embodiments of the invention is shown.

In 800, the method starts.

In 802, a surface 118 of an object 116 is illuminated with a first optical illumination 214A from a first direction, the surface 118 comprising microscopic embossed data units 224 encoding digital information.

In 804, a first primary digital microscopic image is recorded from the microscopic embossed data units 224 with the first optical illumination 214A.

In 806, the surface 118 is illuminated with a second optical illumination 214B from a second direction different from the first direction.

In an embodiment of the invention, the surface 118 is illuminated 802 from the first direction associated with a first incident azimuth angle 304A, and the surface 118 is illuminated 806 from the second direction associated with a second incident azimuth angle 304B different from the first incident azimuth angle 304A.

In an embodiment of the invention, the first incident azimuth angle 304A and the second incident azimuth angle 304B are opposite angles.

In 808, a second primary digital microscopic image is recorded from the microscopic embossed data units 224 with the second optical illumination 214B.

In an embodiment of the invention, the surface 118 is illuminated 802 with the first optical illumination 214A during a first time interval, and the surface 118 is illuminated 806 with the second optical illumination 214B during a second time interval different from the first time interval.

In an embodiment of the invention, the surface 118 is illuminated 802 with the first optical illumination 214A covering a first optical spectral range, and the surface 118 is illuminated 806 with the second optical illumination 214B covering a second optical spectral range different from the first optical spectral range, and the first primary digital microscopic image is recorded 804 at the first spectral range, and the second primary digital microscopic image is recorded 806 at the second spectral range.

In 810, a secondary digital microscopic image of the microscopic embossed data units 224 is generated from the first primary digital microscopic image and the second primary digital microscopic image.

In an embodiment, topographic information of the microscopic embossed data units 224 is generated 810 from the first primary digital microscopic image and the second primary digital microscopic image and the topographic information is incorporated into the secondary digital microscopic image.

In an embodiment, a difference image between the first primary digital microscopic image and the second primary digital microscopic image is calculated, and an integral of the difference image over the surface is calculated. Furthermore, the integral is incorporated into the secondary digital microscopic image.

In an embodiment of the invention, a sum of the first primary digital microscopic image and the second primary digital microscopic image is calculated, and the difference image is normalized with the sum image. Furthermore, the integral is incorporated into the secondary digital microscopic image.

In 812, at least a part of the digital information is decoded from the secondary digital microscopic image.

In 814, the method ends.

Even though the invention has been described above with reference to an example according to the accompanying drawings, it is clear that the invention is not restricted thereto but it can be modified in several ways within the scope of the appended claims.

1. A wireless telecommunication device, comprising:
an illuminating system for illuminating a surface of an object with a first optical illumination from a first direction, the illumination system further being configured to illuminate the surface with a second optical illumination from a second direction different from the first direction, the surface comprising microscopic embossed data units encoding digital information;
a digital microscope camera for recording a first primary digital microscopic image from the microscopic embossed data units with the first optical illumination, the digital microscope camera further being configured to record a second primary digital microscopic image from the microscopic embossed data units with the second optical illumination;
an image processing unit for generating a secondary digital microscopic image of the microscopic embossed data units from the first primary digital microscopic image and the second primary digital microscopic image; and
an image decoder for decoding at least a part of the digital information from the secondary digital microscopic image.

2. The wireless telecommunication device of claim 1, wherein the illuminating system is configured to illuminate the surface with the first optical illumination during a first time interval, the illuminating system further being configured to illuminate the surface with the second optical illumination during a second time interval different from the first time interval.

3. The wireless telecommunication device of claim 1, wherein the illuminating system is configured to illuminate the surface with the first optical illumination covering a first optical spectral range, the illuminating system further being configured to illuminate the surface with the second optical illumination covering a second optical spectral range different from the first optical spectral range; and
wherein the digital microscope camera is configured to record the first primary digital microscopic image at the first spectral range, the digital microscope camera further being configured to record the second primary digital microscopic image at the second spectral range.

4. The wireless telecommunication device of claim 1, wherein the illuminating system is configured to illuminate the surface from the first direction associated with a first incident azimuth angle, the illuminating system further being configured to illuminate the surface from the second direction associated with a second incident azimuth angle different from the first incident azimuth angle.

5. The wireless telecommunication device of claim 4, wherein the first incident azimuth angle and the second incident azimuth angle are opposite angles.

6. The wireless telecommunication device of claim 1, wherein the optical magnification of the digital microscope camera is between 0.1 and 2.

7. The wireless telecommunication device of claim 1, further comprising:
an integrated matrix detector integrated into the wireless telecommunication device; and
a microscope imaging module comprising optics for providing means for microscopic imaging, and the illuminating system, the microscope optics module further comprising an interface for enabling post-installation of the microscope imaging module into the wireless telecommunication device.

8. The wireless telecommunication device of claim 1, further comprising a light block for reducing external light entering to the surface 118.

9. The wireless telecommunication device of claim 1, wherein the image processing unit is configured to generate topographic information of the microscopic embossed data units from the first primary digital microscopic image and the second primary digital microscopic image and to incorporate the topographic information into the secondary digital microscopic image.

10. The wireless telecommunication device of claim 1, wherein the image processing unit is configured to calculate a difference image between the first primary digital microscopic image and the second primary digital microscopic image; and
wherein the image processing unit is further configured to calculate an integral of the difference image over the surface and to incorporate the integral into the secondary digital microscopic image.

11. The wireless telecommunication device of claim 10, wherein the image processing unit is further configured to calculate a sum of the first primary digital microscopic image and the second primary digital microscopic image and to normalize the difference image with the sum image; and
wherein the image processing unit is configured to incorporate the integral into the secondary digital microscopic image.

12. The wireless telecommunication device of claim 1, wherein the first direction and the second direction are selected according to characteristics of the microscopic embossed data units.

13. The wireless telecommunication device of claim 1, wherein the digital microscopic camera has been located according to characteristics of the microscopic embossed data units.

14. The wireless telecommunication device of claim 1, wherein the image processing unit is configured according to characteristics of the microscopic embossed data units.

15. A wireless telecommunication device, comprising:
an illuminating means for illuminating a surface of an object with a first optical illumination from a first direction, the illuminating means further being configured to illuminate the surface with a second optical illumination from a second direction different from the first direction, the surface comprising microscopic embossed data units encoding digital information;
a recording means for recording a first primary digital microscopic image from the microscopic embossed data units with the first optical illumination, the recording means further being configured to record a second primary digital microscopic image from the microscopic embossed data units with the second optical illumination;
a generating means for generating a secondary digital microscopic image of the microscopic embossed data units from the first primary digital microscopic image and the second primary digital microscopic image; and
a decoding means for decoding at least a part of the digital information from the secondary digital microscopic image.

16. A decoding system for decoding digital information, comprising:
an illuminating means for illuminating a surface of an object with a first optical illumination from a first direction, the illuminating means being located in a wireless telecommunication device and configured to illuminate the surface with a second optical illumination from a second direction different from the first direction, the surface comprising microscopic embossed data units encoding digital information;
a recording means for recording a first primary digital microscopic image from the microscopic embossed data units with the first optical illumination, the recording means being located in a wireless telecommunication device and configured to record a second primary digital microscopic image from the microscopic embossed data units with the second optical illumination;
a generating means, located in a computing system, for generating a secondary digital microscopic image of the microscopic embossed data units from the first primary digital microscopic image and the second primary digital microscopic image; and
a decoding means, located in a computing system, for decoding at least a part of the digital information from the secondary digital microscopic image.

17. A computer program encoding instructions for executing a computer process suitable for decoding digital information, the computer process comprising:
outputting a command for illuminating a surface of an object with a first optical illumination from a first direction, the surface comprising microscopic embossed data units encoding digital information;
recording a first primary digital microscopic image from the microscopic embossed data units with the first optical illumination;
outputting a command for illuminating the surface with a second optical illumination from a second direction different from the first direction;
recording a second primary digital microscopic image from the microscopic embossed data units with the second optical illumination;
generating a secondary digital microscopic image of the microscopic embossed data units from the first primary digital microscopic image and the second primary digital microscopic image; and
decoding at least a part of the digital information from the secondary digital microscopic image.

18. A method of decoding digital information, comprising:
illuminating a surface of an object with a first optical illumination from a first direction, the surface comprising microscopic embossed data units encoding digital information;
recording a first primary digital microscopic image from the microscopic embossed data units with the first optical illumination;
illuminating the surface with a second optical illumination from a second direction different from the first direction;
recording a second primary digital microscopic image from the microscopic embossed data units with the second optical illumination;
generating a secondary digital microscopic image of the microscopic embossed data units from the first primary digital microscopic image and the second primary digital microscopic image; and
decoding at least a part of the digital information from the secondary digital microscopic image.
